(19) United States
(12) Patent Application Publication
(10) Pub. No.: US 2011/0234631 A1
(43) Pub. Date: Sep. 29, 2011

(54) AUGMENTED REALITY SYSTEMS

(75) Inventors: Jae-Hyung KIM, Seoul (KR); Jong-Cheol HONG, Seoul (KR); Jong-Min YOON, Incheon (KR); Ho-Jong JUNG, Incheon (KR)

(73) Assignee: BIZMODELINE CO., LTD., Seoul (KR)

(21) Appl. No.: 12/731,307

(22) Filed: Mar. 25, 2010

(51) Int. Cl. G09G 5/00

(52) U.S. Cl. 345/632

(57) ABSTRACT

Apparatuses and techniques relating to an augmented reality (AR) device are provided. The device for augmenting a real-world image includes a light source information generating unit that generates light source information for a real-world image captured by a real-world image capturing device based on the location, the time, and the date the real-world image was captured. The light source information includes information on the position of a real-world light source for the real-world image. The device further includes a shadow image registration unit that receives the light source information generated from the light source information generating unit. The shadow image registration unit generates a shadow image of a virtual object overlaid onto the real-world image based on the light source information generated from the light source information generating unit.

### BACKGROUND

Augmented reality (AR) focuses on combining real world and computer-generated data, especially computer graphics objects blended into real footage in real time for display to an end-user. The scope of AR has expanded to include non-visual augmentation and broader application areas, such as advertising, navigation, military services and entertainment to name a few. For its successful deployment, an interest has been grown to provide seamless integration of such computer-generated data (images) into real-world scenes.

### SUMMARY

Techniques relating to an augmented reality (AR) device are provided. In one embodiment, a device for augmenting a real-world image includes a light source information generating unit that generates light source information for a real-world image captured by a real-world image capturing device based on the location, the time, and the date the real-world image was captured. The light source information includes information on the position of a real-world light source for the real-world image. The device further includes a shadow image registration unit that receives the light source information generated from the light source information generating unit. The shadow image registration unit generates a shadow image of a virtual object overlaid onto the real-world image based on the light source information generated from the light source information generating unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows a schematic block diagram of an illustrative embodiment of an augmented reality (AR) system.

FIG. 2A-2C show an illustrative embodiment for generating an augmented reality image overlaid with a shadow image of a virtual object.

FIG. 3 shows a schematic block diagram of an illustrative embodiment of the image capture unit of FIG. 1.

FIG. 4 shows a schematic block diagram of an illustrative embodiment of the AR generator of FIG. 1.

FIG. 5 shows a schematic block diagram of an illustrative embodiment of the AR image generating unit of FIG. 4.

FIG. 6 shows an illustrative embodiment for selecting and registering a virtual object and generating a virtual shadow image of the virtual object based on a markerless selection/registration technique.

FIG. 7A-7C shows a schematic diagram of another illustrative embodiment of an AR system.

FIG. 8 shows an example flow diagram of an illustrative embodiment of a method for generating a AR image.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Augmented reality (AR) technology blends real world images with the images of virtual objects to provide the illusion to viewers that the virtual objects exist in the real world. Techniques described in the present disclosure employ a novel AR device to produce blended images that include virtual shadow images of the virtual objects that conforms to or is consistent with the real-world shadow images of real objects in the real image, such that the virtual shadow images appear to the viewer as if it were cast by the same real-world light source (e.g., the sun) that cast the real-world shadow images.

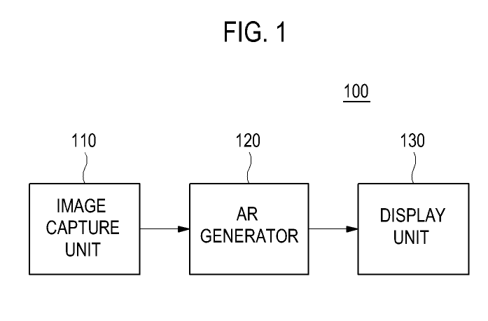

FIG. 1 shows a schematic block diagram of an illustrative embodiment of an augmented reality (AR) system. Referring to FIG. 1, an AR system 100 may include an image capture unit 110 configured to capture a real-world image, an AR generator 120 configured to generate an AR image by overlaying the captured real-world image with the image(s) of one or more virtual object(s) and their respective virtual shadow images, and a display unit 130 configured to display the augmented reality image generated by AR generator 120.

As used herein, the term “virtual object” refers to a geometric representation of an object, and the term “virtual shadow image” refers to a shadow image of the virtual object rendered using one or more shadow rendering techniques known in the art. Examples of such shadow rendering techniques include, but are not limited to, a shadow map algorithm, a shadow volume algorithm, and a soft shadow algorithm. The technical details on the virtual object and the virtual shadow image are well known in the art and are not explained further herein.

Image capture unit 110 may include one or more digital cameras (not shown) for capturing a real-world image of a real-world scene. In one embodiment, image capture unit 110 may be remotely located from AR generator 120, and may be wirelessly connected with AR generator 120. In another embodiment, image capture unit 110 may be arranged in the same case that houses AR generator 120.

AR generator 120 may be configured to generate a virtual shadow image(s) of the virtual object(s) whose image(s) are to be overlaid onto the real-world image captured by image capture unit 110. The virtual object(s) may be pre-stored in AR generator 120, or may be received by AR generator 120 from an external device (e.g., a server). In one embodiment, AR generator 120 may be configured to generate virtual shadow images whose size, shape, direction, and/or intensity conform to or is consistent with the real-world shadow images of real objects in the real-world image. The virtual shadow images generated in such a manner may appear to the viewer of the AR image as if it were cast by the same real-world light source that cast the real-world shadow images.

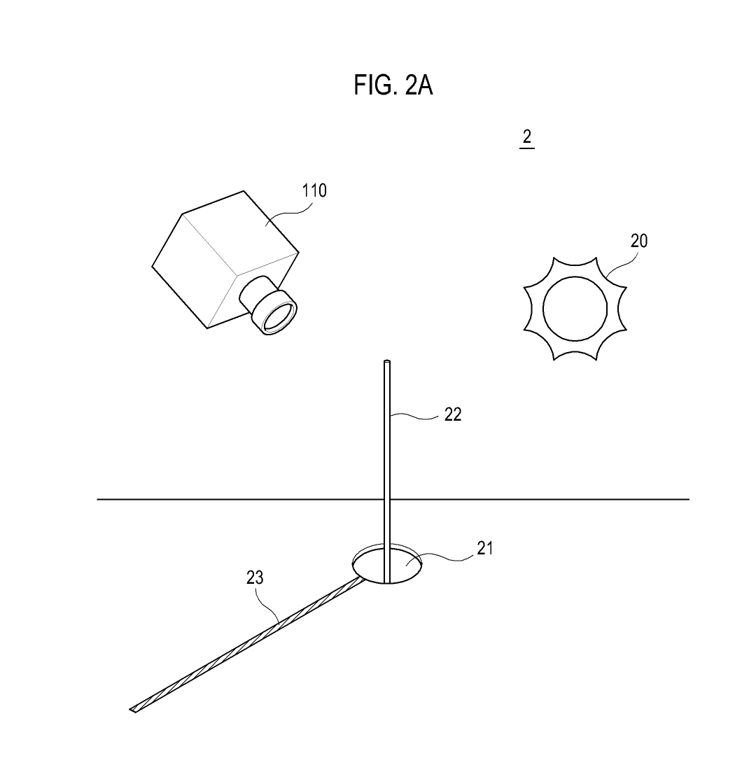

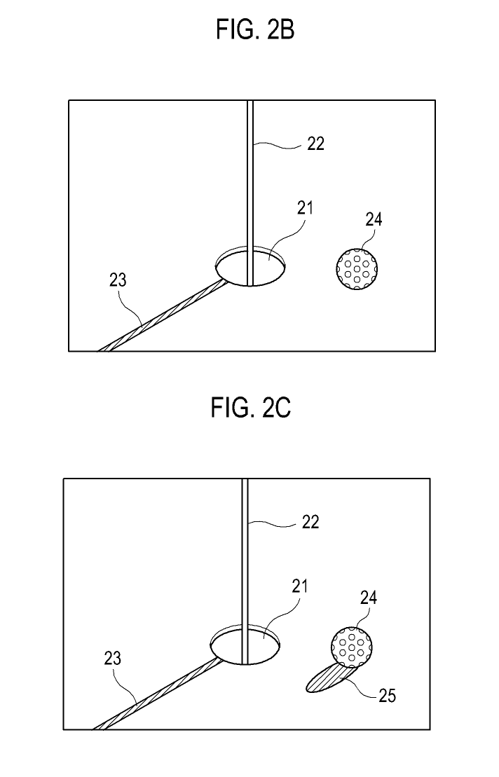

FIGS. 2A-2C show an illustrative embodiment for generating an AR image overlaid with a virtual image and its virtual shadow image. FIG. 2A shows an illustrative embodiment of a perspective view of a real world scene, FIG. 2B shows an illustrative embodiment of an AR image of the real world scene of FIG. 2A without a virtual shadow image of a virtual object, and FIG. 2C shows an illustrative embodiment of an AR image of the real world scene of FIG. 2A including a virtual shadow image of the virtual object. Referring to FIGS. 2A-2C, a real world scene 2 in FIG. 2A includes a sun 20, a golf hole 21, a pole 22 therein, and a real-world shadow 23 of pole 22. Image capture unit 110 generates and provides a real-world image of such real-world scene 2 to AR image generator 120. A golf ball 24 in FIGS. 2B and 2C and its shadow image 25 in FIG. 2C are virtual images added by AR image generator 120. Virtual shadow image 25 of golf ball 24 in FIG. 2C is in the same direction as real-world shadow 23 of pole 22 cast by real world sun 20, as if virtual shadow image 25 has also been cast by real-world sun 20. As can be appreciated by comparing FIGS. 2B and 2C, added virtual shadow image 25 breathes realism into the virtual image of golf ball 24 added to the AR image, giving the illusion as if it really exists in the real world.

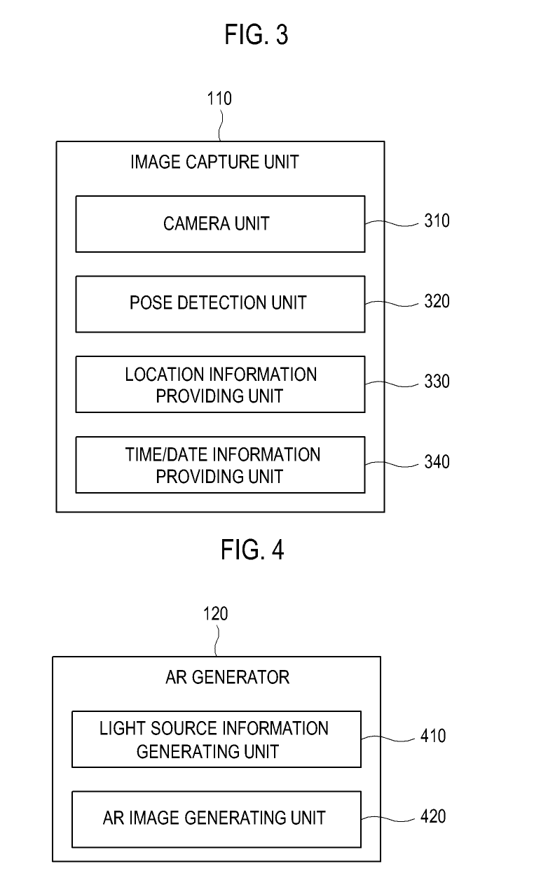

Returning to FIG. 1, AR generator 120 may be configured to estimate the location of a real-world light source (e.g., the sun) with respect to image capture unit 110, and to generate the virtual shadow images based on the estimated location. In one embodiment, AR generator 120 may be configured to estimate the position of the real-world light source based on the location, the time, and the date the real-world image was captured by image capture unit 110. AR generator 120 may at least partially obtain such information on the location, the time, and/or the date from camera unit 110 and/or an external device (e.g., a server). The technical details on (a) estimating the location of the sun and (b) generating virtual shadow images and AR images therefrom will be explained in detail below with reference FIGS. 3-5.

Display unit 130 may be configured to display the augmented reality image provided by AR generator 120. In one embodiment, display unit 130 may be implemented with a cathode ray tube (CRT), a liquid crystal display (LCD), a light-emitting diode (LED), an organic LED (OLED), and/or a plasma display panel (PDP).

FIG. 3 shows a schematic block diagram of an illustrative embodiment of the image capture unit of FIG. 1. Referring to FIG. 3, image capture unit 110 may include a camera unit 310 configured to generate a real-world image and a pose detection unit 320 configured to measure the bearing and the tilt of camera unit 310 and to generate pose information (which includes information on the measured bearing and the tilt). In another embodiment, image capture unit 110 may optionally include a location information providing unit 330 and/or a time/date information providing unit 340.

Camera unit 310 may include one or more digital cameras (not shown) that convert an optical real-world image into digital data. Examples of such digital cameras include, but are not limited to, charge-coupled device (CDD) digital cameras and complementary metal-oxide-semiconductor (CMOS) digital cameras.

Pose detection unit 320 may be configured to measure the bearing and tilt of the respective digital cameras. In one embodiment, pose detection unit 320 may include a terrestrial magnetic field sensor (e.g., a compass) (not shown) configured to detect the bearing (e.g., north, south, east, and west direction) of the respective digital cameras of camera unit 310, and a gyro sensor (not shown) that measures the tilt of the respective digital cameras of camera unit 310.

Location information providing unit 330 may be configured to provide information on location at which the real-world image was captured by camera unit 310 (i.e., location information). In one embodiment, location information providing unit 330 may include a GPS unit (not shown) configured to receive GPS information wirelessly received from multiple GPS satellites, and determine the location of image capture unit 110 based on the received GPS information by using a GPS technique.

In another embodiment, location information providing unit 330 may include a mobile tracking unit (not shown) configured to receive mobile tracking information from an external device (e.g., a server or a wireless network entity), and determine the location of image capture unit 110 based on the received mobile tracking information by using a mobile tracking technique. As used herein, mobile tracking information is defined as information that may be used by location information providing unit 330 to determine the location of image capture unit 110 based on one or more mobile tracking techniques. Examples of such mobile tracking techniques include, but are not limited to, cell identification, enhanced cell identification, triangulation (e.g., uplink time difference of arrival (U-TDOA)), time of arrival (TOA), and angle of arrival (AOA) techniques. Further, examples of such mobile tracking information include, but are not limited to, cell information indicating the cell in which camera unit 110 is located, and identification (ID) information uniquely identifying image capture unit 110.

In one example using the cell identification as the mobile tracking technique, location information providing unit 330 may receive as mobile tracking information cell information (e.g., a cell ID) indicating the cell in which image capture unit 110 is located, and then, estimate the location of image capture unit 110 based on the received cell information (e.g., determining and selecting the center point of the coverage area of the cell identified by the received cell information as the location of image capture unit 110). The technical details for the cell identification technique is well known in the art, and is not further discussed herein. In another example, location information providing unit 330 may receive identification (ID) information of image capture unit 110 from a base station or other equivalent device in wireless communication therewith, transmit the received ID information to an external device (e.g., a server) (so as to enable the server to obtain information on image capture unit 110 from wireless network entities for determining the location), and receive in response from the server information on the location of image capture unit 110.

Time/date information providing unit 340 may be configured to provide information on the time and date the real-world image was captured by camera unit 310. In one embodiment, time/date information providing unit 340 may be installed with a clock. In another embodiment, time/date information providing unit 340 may receive current time and date information from an external device (e.g., a server or a base station or a wireless communication network).

Location information providing unit 330 and time/date information providing unit 340 may be implemented with a wireless communication unit (not shown) configured to communicate information with an external device (e.g., a server or a base station or a wireless communication network). For example, the wireless communication may be configured to receive the GPS information, the mobile tracking information, and/or time/date information from the external device to provide them to AR generator 120.

FIG. 4 shows a schematic block diagram of an illustrative embodiment of the AR generator of FIG. 1. Referring to FIG. 4, AR generator 120 may include a light source information generating unit 410 in communications with image capture unit 110 and configured to generate light source information (which includes the information on the position of the real-world light source with respect to image capture unit 110) for the real-world image captured by image capture unit 110. AR generator 120 may further include an AR image generating unit 420 configured to generate, based on the light source information, a shadow image of a virtual shadow image of a virtual object whose image is to be overlaid onto or blended with the real-world image. In one embodiment, AR image generating unit 420 may generate an AR image by blending the real-world image with the virtual object image and the generated virtual shadow image.

In one embodiment, light source information generating unit 410 may estimate the location of the real-world light source (e.g., the sun's position in the sky) based on the location, the time, and the date the real-world image was captured by image capture unit 110. Light source information generating unit 410 may determine the location and/or the time and date of the real-world image based at least partially on the location, time, and date information provided by image capture unit 110 and/or an external device (e.g., a server).

With regard to the time and date determination, in one embodiment, light source information generating unit 410 may receive from image capture unit 110, together with the real-world image, information on the time and date the real-world image was captured. In another embodiment, light source information generating unit 410 may periodically receive the current time and date from a clock (not shown) installed in AR generator 120 or an external device (e.g., a server), and set the time and date the real-world image was received from image capture unit 110 as the time and date the real-world image was captured by image capture unit 110.

Light source information generating unit 410 may estimate the location of the real-world light source (e.g., the sun's position in the sky) based on the determined location, the time, and the date the real-world image was captured by image capture unit 110. Technique(s) well known in the art for calculating the position of the sun at a prescribed location for a prescribed time and date may be used. For example, the solar position algorithm (SPA) provided by National Renewable Energy Laboratory (NREL) of U.S. Department of Energy may be used. Further technical details on the SPA may be found in Reda, I., Andreas, A., Solar Position Algorithm for Solar Radiation Applications, 55 pp., NREL Report No. TP-560-34302, Revised January 2008, which are incorporated herein in its entirety by reference. In another example, solar position calculator provided by the National Oceanic and Atmospheric Administration of the U.S. Department of Commerce may be used.

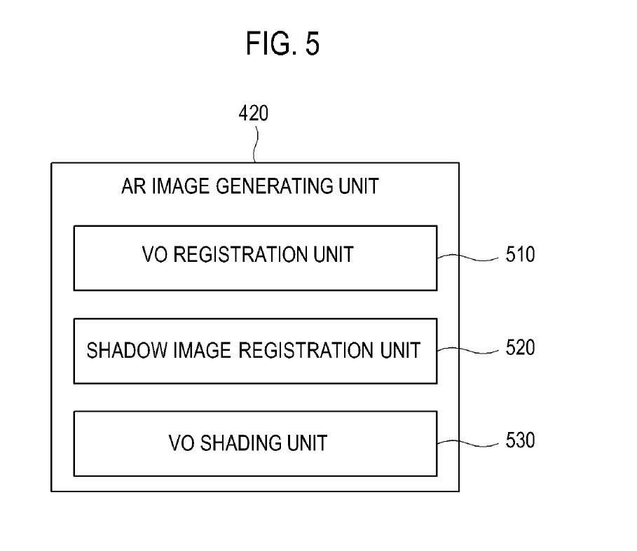

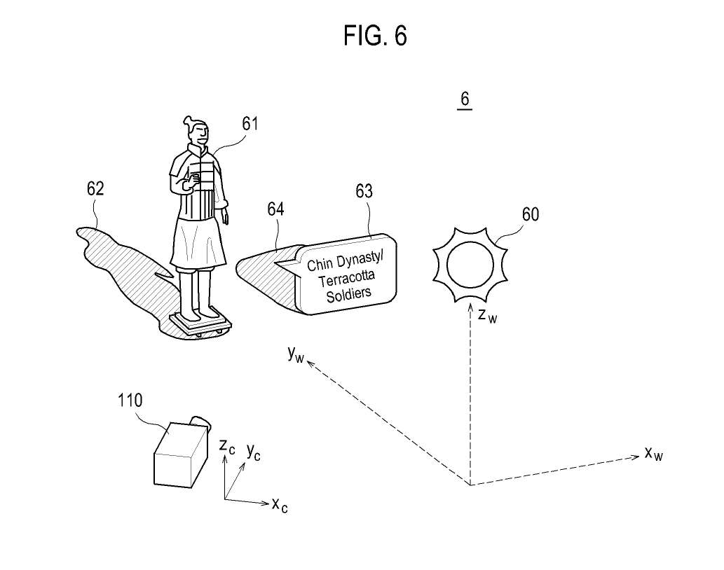

AR image generating unit 420 may receive the real-world image from image capture unit 110 and obtain a virtual object that is to be overlaid onto the received real-world image based on the received real-world image. In one embodiment, AR image generating unit 420 may select a virtual object from a pool of virtual objects pre-stored in a storage unit (not shown) installed in AR generator 120. In another embodiment, AR image generating unit 420 may transmit the received real-world image to an external device (e.g., a server) (such that the server may select a virtual object from a pool of virtual objects stored therein) and receive therefrom a selected virtual object. The technical details on virtual object selection will be explained in detail below with reference FIGS. 5 and 6.

AR image generating unit 420 may respectively receive pose information (e.g., the bearing and the tilt of image capture unit 110) and light source information from image capture unit 110 and light source generating unit 410, and generate a virtual shadow image of the selected virtual object based at least partially on the pose information and the light source information. AR image generating unit 420 may generate an AR image by overlaying the received real-world image with the image of the selected virtual object and the generated virtual shadow image. The technical details on virtual shadow image and AR image generation will be explained in detail below with reference FIGS. 5 and 6.

FIG. 5 shows a schematic block diagram of an illustrative embodiment of the AR image generating unit of FIG. 4. Referring to FIG. 5, AR image generating unit 420 may include a virtual object (VO) registration unit 510 configured to select a virtual object from a pool of virtual objects (e.g., stored in the storage unit of AR generator 120 or in an external device (not shown) in communications with AR generator 120) and to register (i.e., align) the selected virtual object with a real world image captured by image capture unit 110; a shadow image registration unit 520 configured to generate a shadow image of the selected virtual object based on the light source information provided by light source information generating unit 410; and a VO shading unit 530 configured to perform a shading operation on the registered image of the VO.

VO registration unit 510 may be configured to select an appropriate virtual object(s) for a given real world image and to register the selected virtual object(s) to the given real world image by employing a marker-based selection/registration technique(s), a markerless selection/registration technique(s), and/or a hybrid selection/registration technique(s) known in the art. In one embodiment employing one of the markerless selection/registration technique(s) to select and register a virtual object to the given real world image, VO registration unit 510 may be configured to compare at least one portion of the captured real world image with one or more template images (e.g. template images stored in the storage unit of AR generator 120 or an external device), and if there is a match, to select and to register the virtual object that corresponds to the matched template image with the matched portion of the captured real world image. Template images may be predetermined images (e.g., an image of a terracotta soldier of the Chin dynasty, a marker image, etc.) that may be used in finding a position in the real world image that is to be overlaid with the one or more virtual objects and/or in selecting one or more appropriate virtual objects that are to be overlaid at the found position. In one embodiment, VO registration unit 510 may be configured to find the portions in the real-world image that are identical or similar to a template image (i.e., finding a match), and overlay the virtual object that corresponds to the matched template image at or near the identified portion of the real-world image. Various conventional similarity or difference measures, such as distance-based similarity measures, feature-based similarity measures, etc., may be employed in finding the portions in the real-world image that are identical or similar to a template image. The template images may be stored in the same storage unit as a virtual object or a separate storage unit, depending on particular implementations. The technical details on VO registration unit 510 selecting and registering a virtual object and generating a virtual shadow image of the virtual object are described in detail in the ensuing descriptions.

FIG. 6 shows an illustrative embodiment for selecting and registering a virtual object and generating a virtual shadow image of the virtual object based on a markerless selection/registration technique. FIG. 6 illustrate a scene 6 including a real-world sun 60, a real-world statue 61, and a real-world shadow 62 of real-world statue 61 cast by real-world sun 60. FIG. 6 further illustrates an image capture unit 110 positioned to capture a real-world image including real-world statue 61 and its real-world shadow 62. Reference frames x_{w}, y_{w}, and z_{w} and reference frames x_{c}, y_{c}, and z_{c} shown in FIG. 6 denote the real-world reference frame (e.g., the reference frame for denoting the position of real-world sun 60 in the sky) and the reference frame of image capture unit 110 (i.e., the camera reference frame), respectively.

For example, the storage unit in AR generator 120 may store various template images of statues (e.g. including a template image of a terracotta soldier of the Chin dynasty) and corresponding virtual objects that include descriptions thereon (e.g. a virtual object 63 with description “Chin dynasty/Terracotta Soldier”). VO registration unit 510, upon receiving the real world image captured by image capture unit 110, may determine whether there is a template image in the various stored template images that is substantially identical or similar to the portion of the real-world image showing real-world statue 61, and select the virtual object (e.g., virtual object 63) that corresponds to the matched template image. For example, VO registration unit 510 may store a table listing multiple virtual objects and corresponding template images, and once a match is found, select the virtual object(s) that corresponds to the matched template image.

Upon selecting a virtual object to be overlaid onto the real-world image, VO registration unit 510 may register the selected virtual object with the real world image. As well known in the art, the registration involves determining the position of the camera reference frame (e.g., x_{c}, y_{c}, and z_{c}) relative to the real world reference frame (e.g., x_{w}, y_{w}, and z_{w}) and determining the position of the virtual object with respect to the camera reference frame. In one embodiment, VO registration unit 510 may determine the camera reference frame based on the pose information (i.e., information on the bearing and tilt of image capture unit 110 with respect to the real-world reference frame) provided by pose detection unit 320. Thereafter, VO registration unit 510 may determine the position of the selected virtual object (e.g., virtual object 63) with respect to the camera reference frame. For example, VO registration unit 510 may position virtual object 63 at a location in proximity to real-world statue 61. The techniques for performing the above registration operations are well known in the art, and will be not discussed in detail for the sake of clarity. It should be understood that the virtual object selection and registration techniques explained above are for illustrative purposes only, and any of the known selection and registration techniques in the art may be employed as appropriate for a particular embodiment.

Shadow image registration unit 520 may be configured to receive the light source information from light source information generating unit 410 and to generate a shadow image of the selected virtual object based on the light source information. In one embodiment, shadow image registration unit 520 may be configured to determine the position of the real-world light source (e.g., real-world sun 60) with respect to the camera reference frame based on the light source information (e.g., including information on the position of real-world sun 60 in the sky or with respect to the real-world reference frame), and to generate a virtual shadow image (e.g., a virtual shadow image 64) of the registered virtual object based on the determined position of the real-world light source.

In one embodiment, shadow image registration unit 520 may set a virtual light source simulating the real-world light source at the determined position, and render the virtual shadow image with respect to the set virtual light source. In rendering the shadow image, shadow image registration unit 520 may include units for respectively performing one or more shadow rendering techniques known in the art. In one example, shadow image registration unit 520 may include at least one of a shadow map unit configured to perform a shadow map algorithm to render the shadow image, a shadow volume unit configured to perform a shadow volume algorithm to render the shadow image, and a soft shadow unit configured to perform a soft shadow algorithm to render the shadow image. The shadow rendering operations performed by the above units are well known in the art, and are not further discussed herein.

According to the above configuration, shadow image registration unit 520 may generate a virtual shadow image(s) of the selected virtual object(s) based on the light source information, such that the size, the shape, the direction, and the intensity of the generated shadow image(s) are consistent in direction, shape, and/or size with those of a shadow(s) in the real world image cast by a real world light source. This is because the virtual shadow image(s) were generated using a virtual light source that has been set up in a position that corresponds to the position of the real-world sun in the sky or with respect to the real-world reference frame).

VO shading unit 530 may be configured to perform shading operations on the registered image of the virtual object(s) based on the light source information and the pose information, such that the shading (e.g., the variance in color and brightness) of the surface of the virtual object(s) is consistent with those of the real world image due to the real world light source. One of various known shading algorithms may be employed in performing the shading operations. Examples of such shading algorithms include, but are not limited to, Lambert, Gouraud, Phong, Blinn, Oren-Nayar, Cook-Torrance, and Ward anisotropic algorithms. For example, VO shading unit 530 may be configured to perform lighting or brightness computations based on the Phong reflection model to produce color intensities at the vertices of a virtual object.

It should be appreciated that an AR generator in accordance with the present disclosures may perform operations other than aforementioned operations. In one embodiment, an AR generator may be configured to consider weather information and/or geographical information pertinent to a real-world image. The AR generator (e.g., the shadow image registration unit of the AR generator) may receive weather information and/or geographical information from an image capture unit (e.g., 110) and/or an external device (e.g., a server), and generate a shadow image(s) and/or render the images of selected virtual objects based on the weather and/or geographical information. For example, the shadow image registration unit may generate darker and more clearly-defined shadow image(s) for real-world images captured under clear weather and lighter and blurry shadow image(s) captured under cloudy weather. Further, for example, the shadow image registration unit may generate darker and more clearly-defined shadow image(s) for real-world images captured in rural areas and lighter and blurry shadow image(s) for real-world images captured in downtown areas. Clouds in cloudy weather and high-storey buildings of downtown areas may scatter the rays from the sun, thereby preventing casting of a clearly-defined dark shadow. The shadow image registration unit may further consider the weather information and/or the geographical information in performing shading operations on a registered image of a virtual object(s).

In addition, there may be instances where the pose (and thus, the point of view) of an image capture unit is changed by a user or by some other means. In one embodiment, an AR generator may track such changes in the pose of an image capture unit (e.g., 110) and re-register a registered virtual object (e.g., update the relationship between a camera reference frame (e.g., x_{c}, y_{c}, and z_{c}) and a real-world reference frame (e.g., x_{w}, y_{w}, and z_{w})). A shadow image registration unit (e.g., 520) of the AR generator may generate a new virtual shadow image based on the re-registration. In one embodiment, a VO registration unit (e.g., 510) of the AR generator may perform tracking by employing a marker-based tracking technique(s), a markerless tracking technique(s), and/or a hybrid tracking technique(s) known in the art. In another embodiment, the VO registration unit may perform tracking by periodically or intermittently receiving pose information updates from a pose detection unit (e.g., 320) installed in the image capture unit.

As described above, an AR generator may include a storage unit (not shown) configured to store data of one or more virtual objects. In one embodiment, the storage unit may store, per virtual object, data on the shape and/or texture of the virtual object. In one embodiment, the storage unit may store various types of data and programs capable of processing (e.g., registering, shading, or rendering) various types of images. The storage unit may include any type of computer-readable media, such as semiconductor media, magnetic media, optical media, tape, hard disk, or the like. In addition, the storage unit may be a detachable memory to allow replacement if and/or when necessary (e.g., when becoming full).

AR system 100 described in conjunction with FIGS. 1-6 may be implemented in a variety of ways. In one embodiment, image capture unit 110 may be implemented as a wireless communication terminal, and AR generator 120 may be implemented as a remote device (e.g., a server remotely located with respect to image capture unit 110) in wireless communication with the wireless communication terminal. In another embodiment, all or some of the units displayed in FIG. 1 may be implemented as a single computing device with wireless communication functionality (e.g., image capture unit 110, AR generator 120, and optionally, display unit 130 may be arranged in a single housing). Examples of such computing device include, but are not limited to, a mobile phone, a mobile workstation and a wearable personal computer (PC), a tablet PC, an ultra mobile PC (UMPC), a personal digital assistant (PDA), a head-up display or a head-mounted display with wireless communication functionality, and a smart-phone.

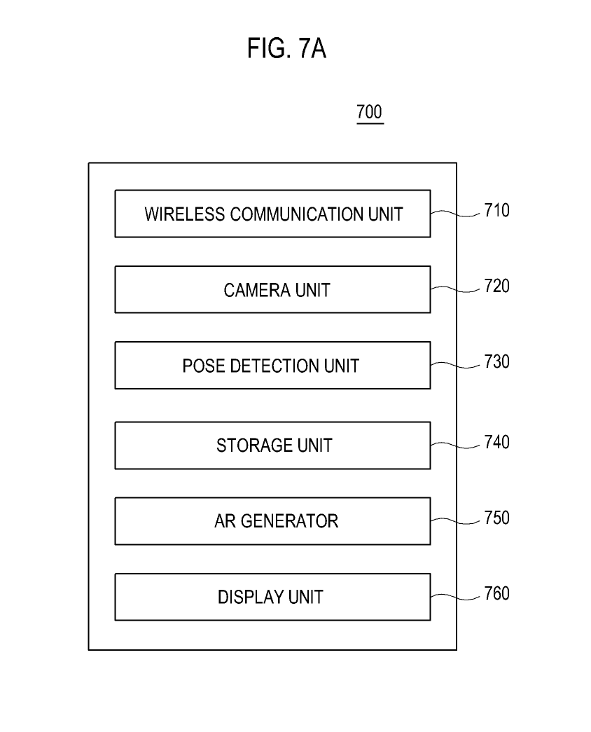

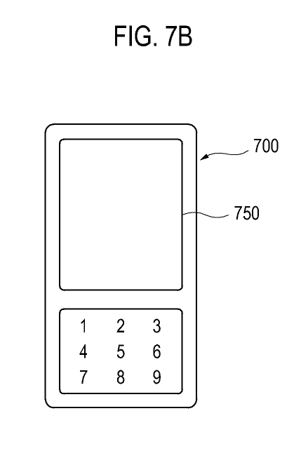

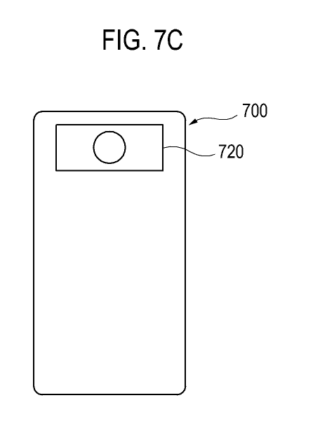

FIG. 7A-7C shows a schematic diagram of another illustrative embodiment of an AR system. FIG. 7A is a block diagram of an AR mobile phone. FIGS. 7B and 7C are a front and rear view of the AR mobile phone. Referring to FIGS. 7A-7C, an AR mobile phone 700 may include a wireless communication unit 710 configured to be in wireless communication with one or more wireless access network entities (not shown) and to receive therefrom information on the time, the date, and/or the location of AR mobile phone 700; a camera unit 720 configured to capture an image of a real-world scene (i.e., a real-world image); a pose detection unit 730 configured to detect the bearing and the tilt of camera unit 720; a storage unit 740 configured to store data of one or more virtual objects; an AR generator 750 configured to generate an AR image by overlaying the captured real world image with the images of the virtual object(s) and the virtual object(s) shadow image(s); and a display unit 760 configured to display the generated AR image.

The structural configurations and functions of camera unit 720, pose detection unit 730, storage unit 740, AR generator 750, and display unit 760 are similar to camera unit 310 of image capture unit 110, pose detection unit 320 of image capture unit 110, the storage unit, AR generator 120, and display unit 130, respectively, described in FIGS. 1-6. For the sake of simplicity, the details on units 720-760 are not further explained.

Wireless communication unit 710 unit may perform at least some of operations performed by location information providing unit 330 and time/date information providing unit 340 of image capture unit 110. In one embodiment, wireless communication unit 710 may include an antenna(s) or one or more wireless communication modules (not shown) respectively adapted to communicate in accordance with one of any suitable wireless communication protocols known in the art. Examples of such wireless communication protocols include, but are not limited to, wireless wide area network (WWAN) protocols (e.g., W-CDMA, CDMA2000), wireless local area network (WLAN) protocols (e.g., IEEE 802.11a/b/g/n), wireless personal area network (WPAN) protocols, and global positioning system (GPS) protocols.

In one embodiment, wireless communication unit 710 may receive from one or more wireless communication network entities (e.g., a base station(s), a server(s), or a satellite(s)) information on the location of AR mobile phone 700 (i.e., location information). In one embodiment, the location information may indicate the exact coordinate (i.e., the longitude and the latitude) or a range of coordinates in which AR mobile phone 700 may be located. In another embodiment, the location information may include information that may be used by AR mobile phone 700 or other devices (e.g., a base station or other wireless network entity) to determine the exact or a range of coordinates in which AR mobile phone 700 may be located. By way of a non-limiting example, such location information may include GPS signals from multiple GPS satellites of a GPS network, cell information from a base station of a W-CDMA network identifying the particular cell in which AR mobile phone 700 is located, and/or information specifying the exact coordinates of AR mobile phone 700 from an external server.

In one embodiment, wireless communication unit 710 may receive from one or more wireless communication network entities (e.g., a base station(s), a server(s), or a satellite(s)) information on the current time and date. In another embodiment, instead of wireless communication unit 710 receiving the time and date information, AR mobile phone 700 may internally include a separate clock unit (not shown) that keeps track of current time and date. Further, in other embodiments, wireless communication unit 710 may receive weather information and/or geographical information from one or more external servers (e.g., a weather information server and/or a geographical information system (GIS) server). The weather information may indicate the weather at the location of AR mobile phone 700. The geographical information may indicate whether AR mobile phone 700 is located in an urban or a rural area.

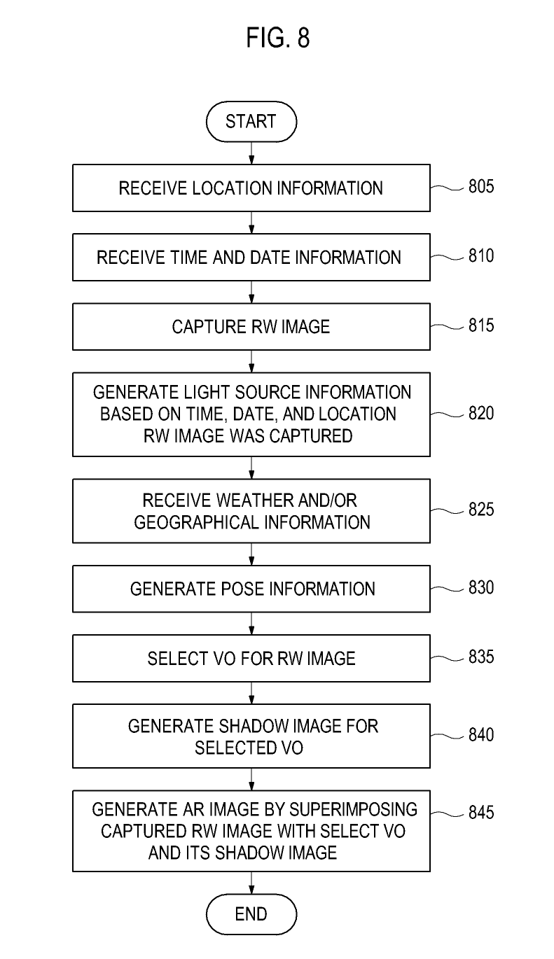

FIG. 8 shows an example flow diagram of an illustrative embodiment for generating an AR image. Referring to FIG. 8, a wireless communication unit of an AR system receives location information from one or more wireless network entities (block 805). In one embodiment, the wireless communication unit may receive GPS signals from one or more GPS satellites as the location information. In another embodiment, the wireless communication unit may receive cell information from a base station in wireless communication with the image capture unit as the location information. In yet another embodiment, the wireless communication unit may transmit identification information of the image capture unit to an external device and receive in response from the external device the location of the image capture unit as the location information.

Also, the wireless communication unit may receive time and date information therefrom (block 810). In block 815, a device (e.g., an image capture unit) included in the AR system captures a real world (RW) image. In block 820, a light source information generating unit of the AR system generates light source information for the captured real-world image (including information on the position of a real-world light source for the real-world image) based on the location, the time, and the date the real-world image was captured. In one embodiment, the light source information generating unit may determine the location the real-world image was captured based on the GPS signals. In another embodiment, the light source information generating unit may determine the location the real-world image was captured based on the cell information. In yet another embodiment, the light source information generating unit may determine the location of the image capture unit received in response from the external device as the location the real-world image was captured.

The wireless communication unit may receive from an external device weather information and/or geographical information (block 825). Further, a pose detection unit of the AR system detects and generates the pose information indicating the bearing and the tilt of the image capture unit (block 830). In block 835, a VO registration unit of the AR system selects and register a virtual object (VO) with the real world image, and in block 840, a shadow image registration unit of the AR system generates a shadow image(s) for the selected VO based on at least one of the light source information, the pose information, the weather information, and/or the geographical information. In block 845, the AR image generating unit of the AR system generates an AR image by superimposing the captured real world image with the image(s) of the virtual object(s) and its shadow image(s).

It should be appreciated that the structural and functional configurations of AR system 100 and its units described in conjunction with FIGS. 1-8 are indicative of a few ways in which AR system 100 may be implemented. In some other embodiments, some of the units or functionalities of AR system 100 may be implemented in one or more other devices in a remote location. For example, in a networked environment, part or all of the components of AR system 100 may be implemented as a distributed system through two or more devices depending on the desired implementations. AR system 100 may operate in a networked environment using logical connections to one or more remote devices, such as a remote computer. The remote computer may be a personal computer, a server, hand-held or laptop devices, a router, a network PC, a peer device, or other common network nodes, and typically may include some or all of the components described in the present disclosure relative to AR system 100.

In one distributed network embodiment, all or some functionalities of light source information generating unit 410 of AR system 100 may be implemented on a separate AR device (e.g., an AR server) in communications with AR system 100. In one example of the above embodiment, AR system 100 may be a mobile phone with a digital camera, and may transmit its identification information (e.g., its phone number or the like) to the AR server such that the AR server may find the location of AR system 100 based on identification information. By way of a non-limiting example, the AR server may include a mobile phone tracking unit that employs one or more known mobile phone tracking algorithms (e.g., a triangulation algorithm) to find the location of an AR system 100. Alternatively, the AR server may forward the identification information to another wireless network entity that provides mobile phone tracking functionality. The AR server can then receive the location of the mobile phone from the wireless network entity. Depending on the particular implementation, the AR server may estimate the position of the real-world light source (e.g., the sun) relative to the mobile phone based on the location of the mobile phone and generate light source information. In the above implementation, the AR server may receive from the mobile phone time and date information for estimating the position of the real-world light source, or alternatively, may include a clock unit that keeps track of the current time and date. In another example of the above embodiment, AR system 100 may be a mobile phone with a digital camera and GPS functionalities, and may transmit information that uniquely identifies itself (e.g., its phone number or the like) and its location to the AR server such that the AR server may estimate the position of the real-world light source relative to the mobile phone based on the received location information. In another distributed network embodiment, all or some of the image processing functionalities of AR system 100 (e.g., the functionalities of VO registration unit 510, shadow image registration unit 520 and/or VO shading unit 530) may be implemented in a separate AR device (e.g., an AR server) in communications with AR system 100. In one example of the above embodiment, AR system 100 may be a mobile phone with a digital camera, and may transmit a real image captured by the digital camera to the AR server such that the AR server may select a virtual object(s) from multiple pre-stored virtual objects, generate a shadow image(s) for the selected virtual object(s), and/or generate an augmented reality image including the selected virtual object(s) and their shadow image(s). In yet another distributed network embodiment, all or some functionalities of VO registration unit 510, light source information generating unit 410, shadow image registration unit 520 and/or VO shading unit 530 of AR system 100 may be implemented in a separate AR device. One skilled in the art would have no difficulty in applying the matters disclosed in this disclosure in realizing a particular implementation appropriate for a particular application. The AR system prepared in accordance with the present disclosure may be used in various applications, such as advertising, navigation, military services and entertainment to name a few.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

It is to be understood that apparatus and methods according to the illustrative embodiments of the present disclosure may be implemented in various forms including hardware, software, firmware, special purpose processors, or a combination thereof. For example, one or more example embodiments of the present disclosure may be implemented as an application having a program or other suitable computer-executable instructions that are tangibly embodied on at least one computer-readable media such as a program storage device (e.g., hard disk, magnetic floppy disk, RAM, ROM, CD-ROM, or the like), and executable by any device or machine, including computers and computer systems, having a suitable configuration. Generally, computer-executable instructions, which may be in the form of program modules, include routines, programs, objects, components, data structures, etc. that perform particular tasks or implement particular abstract data types. The functionality of the program modules may be combined or distributed as desired in various embodiments. It is to be further understood that, because some of the constituent system components and process operations depicted in the accompanying figures can be implemented in software, the connections between system units/modules (or the logic flow of method operations) may differ depending upon the manner in which the various embodiments of the present disclosure are programmed.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third, and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An augmented reality system comprising:
an image capture unit configured to capture a real-world image; and
an augmented reality (AR) generator comprising
a light source information generating unit in communications with the image capture unit and configured to generate light source information for the real-world image captured by the image capture unit, based on at least one of a location, a time, and a date the real-world image is captured, the light source information including information on a position of a real-world light source with respect to the image capture unit, and
an AR image generating unit configured to generate a shadow image of a virtual object based on the generated light source information and to overlay the virtual object and the shadow image onto the real-world image.

2. The system of claim 1, wherein the image capture unit further comprises a pose detection unit configured to measure a bearing and a tilt of the image capture unit.

3. The system of claim 2, wherein the AR image generating unit comprises
a virtual object registration unit configured to determine a reference frame of the image capture unit based on the measured bearing and tilt of the image capture unit, and to determine a position of the virtual object with respect to the reference frame.

4. The system of claim 3, wherein the virtual object registration unit is further configured to perform a marker-based selection/registration technique, a markerless selection/registration technique, or a hybrid selection/registration technique to determine the position of the virtual object with respect to the reference frame.

5. The system of claim 3, wherein the AR image generating unit further comprises
a shadow image registration unit configured to determine a position of the real-world light source with respect to the reference frame based on the light source information, and to generate the shadow image of the virtual object based on the determined position of the real-world light source.

6. The system of claim 5, wherein the shadow image registration unit is further configured to set a virtual light source simulating the real-world light source at the position of the real-world light source, and to render the shadow image with respect to the set virtual light source.

7. The system of claim 6, wherein the shadow image registration unit comprises at least:
a shadow map unit configured to perform a shadow map algorithm to render the shadow image,
a shadow volume unit configured to perform a shadow volume algorithm to render the shadow image, or
a soft shadow unit configured to perform a soft shadow algorithm to render the shadow image.

8. The system of claim 6, wherein
the pose detection unit is configured to provide an update on the bearing and the tilt of the image capture unit; and
the shadow image registration unit is configured to generate a new shadow image based on the update.

9. The system of claim 6, wherein the shadow image registration unit is further configured to receive at least one of weather information and geographical information for the real-world image from a server in communications with the AR system and to set the virtual light source based on at least the weather information or the geographical information for the real-world image.

10. The system of claim 9, wherein the shadow image registration unit is further configured to determine an intensity of the virtual light source based on at least one of the weather information and the geographical information for the real-world image.

11. The system of claim 1, wherein the image capture unit further comprises a wireless communication unit configured to communicate with a base station and to receive cell information therefrom, and wherein the light source information generating unit is further configured to determine the location of the image capture unit based on the received cell information.

12. The system of claim 1, wherein the light source information generating unit is further configured to transmit identification (ID) information of the image capture unit to a server in communications with the AR system and to receive in response from the server the location of the image capture unit.

13. A method for providing augmented reality, the method comprising:
capturing a real-world image;
determining at least one of a location, a time, and a date the real-world image was captured;
generating light source information for the captured real-world image based on at least one of the location, the time, and the date the real-world image was captured, the light source information including information on a position of a real-world light source for the real-world image; and
generating a shadow image of a virtual object overlaid onto the real-world image based on the light source information.

14. The method of claim 13, wherein determining the location the real-word image was captured comprises:
determining a location of a device that captured the real-word image by receiving GPS signals from one or more GPS satellites that are in wireless communications with the device; and
determining the location the real-world image is captured based on the GPS signals.

15. The method of claim 13, wherein determining the location the real-word image was captured comprises:
determining a location of a device that captured the real-word image by receiving cell information from a base station in wireless communications with the device; and
determining the location the real-world image was captured based on the received cell information.

16. The method of claim 13, wherein determining the location the real-word image was captured comprises:
determining a location of a device that captured the real-world image by transmitting identification (ID) information identifying the device to a server in wireless communications with the device;
receiving from the server the location of the device; and
determining the location the real-world image was captured based on the location of the device.

17. The method of claim 13, wherein generating light source information comprises,
measuring a bearing and a tilt of a device that captured the real-world image.

18. The method of claim 17, wherein generating a shadow image comprises:
determining a reference frame of the device that captured the real-world image based on the measured bearing and tilt of the device that captured the real-world image;
determining a position of the virtual object with respect to the reference frame;
determining a position of the real-world light source with respect to the reference frame based on the light source information; and
generating the shadow image of the virtual object based on the determined position of the real-world light source.

19. The method of claim 18, wherein generating the shadow image of the virtual object based on the determined position of the real-world light source comprises:
setting a virtual light source simulating the real-world light source at the position of the real-world light source; and
rendering the shadow image with respect to the set virtual light source.

20. The method of claim 13, wherein generating light source information comprises:
receiving at least one of weather information and geographical information for the real-world image from a server in wireless communication with a device that captured the real-world image; and
generating the shadow image based on at least the weather information or the geographical information.
